(19) United States
(12) Patent Application Publication
(10) Pub. No.: US 2004/0053002 A1
(43) Pub. Date: Mar. 18, 2004

(54) Magnetic message mat

(76) Inventors: Seiin Kobayashi, Yonezawa-shi (JP); Mamiko Yamada, Yonezawa-shi (JP); Takuya Honda, Takatsuki-shi (JP)

Correspondence Address: Charlotte C. Wilson, Legal Department, M-495, P.O. Box 1926, Spartanburg, SC, 29304, US

(21) Appl. No.: 10/460,244

(22) Filed: Jun. 12, 2003

Related U.S. Application Data
(60) Provisional application No. 60/388,328, filed on Jun. 13, 2002.

(51) Int. Cl. B32B 3/14; B32B 3/16; B32B 33/00; B32B 3/06

(52) U.S. Cl. 428/95; 428/77; 428/78; 15/215; 15/217; 428/101

(57) ABSTRACT

A multi-component floor mat that, in one embodiment, is comprised of a first base or frame portion, intended to be positioned on the floor, that is dimensioned to accommodate a second flexible textile mat or rug portion that is releasably held in place on or in said base or frame portion by a plurality of magnets associated with one or both portions, thereby allowing for the easy removal or replacement of the textile portion of the mat and the economical laundering of same. The pile surface of the mat component features one of a plurality of messages, printed in reactive dyes, intended to convey information to users of the mat. The information is selected from the group consisting of factual information, directional information, greeting information, service information, messages pertinent to the time during which said floor mat is displayed, messages pertinent to the local conditions for which said floor mat is displayed, messages pertinent to the immediate area in which said floor mat is displayed, and personal messages.

### CROSS-REFERENCE TO RELATED APPLICATIONS

This application claims priority to U.S. provisional application, serial No. 60/388,328, filed Jun. 13, 2002.

### TECHNICAL FIELD

The present invention relates to a floor mat made of separable components. More specifically, the invention relates to a multi-component floor mat that, in one embodiment, is comprised of a first base or frame portion that is dimensioned to accommodate a second flexible textile mat or rug portion that is releasably held in place on or in said base or frame portion by a plurality of magnets associated with one or both portions.

### BACKGROUND

Dust-control mats, typically used in or near entrances in retail and industrial buildings, offices, and residences, can be classified into two types, according to their essential construction: a unitary mat and a separable mat. Mats of both types are commonly used in industrial laundry businesses that rent the mats to customers for a period of time and then recover, wash, regenerate and re-rent the mat, to the same or to a different customer.

In the case of unitary mats, the base or floor portion and the textile mat portion are constructed as a unitary, inseparable structure. When such mats are used In the industrial laundry business, both portions of the mat—including the base portion (typically made of a relatively thick layer of rubber or similar material)—must be recovered, transported to and from the customer location, washed and regenerated, even though it is likely that only the textile portion requires laundering. Having to include the relatively heavy base or floor portion of the mat in these various operations causes significant and needless inefficiencies due to the additional weight and bulk contributed by the base or floor portion, including the considerable energy costs associated with transporting and washing such mats.

In order to reduce these inefficiencies, and to provide additional flexibility and variety in the choice of the textile portion of the mat, separable mats have been developed. These mats typically are comprised of a base portion and a separate, removable textile portion that is adapted for fitting in or on the base portion. The heavier, bulkier base portion can then remain in place, while the lighter, less bulky textile portion can be removed or exchanged for laundering or, for example, for the purpose of changing the appearance of the mat as an interior design element in a customer's building. Because only the relatively lightweight, compact textile portion need be serviced, industrial launderers can achieve significant economies during the collecting, laundering, and re-distributing processes that such laundries routinely undertake during the lifetime of the textile portion of the mat, and substantial cost savings can be realized if the relatively heavy and bulky base portion can be left in place. p The concept on which such separable mats are based is that the base portion, being made of rubber or the like, can remain in place on a semi-permanent basis once it is placed in the desired location. Thereafter, the textile portion of the mat can be replaced or exchanged as housekeeping or interior design needs arise. Accordingly, in addition to a reduction in the inefficiencies referred to above, an interchangeable system of mats can be produced to meet a variety of user needs and specifications, making it possible to offer a wide variety of mats at relatively modest cost, and allowing for easy replacement or substitution of the textile portion of the mat.

The separable mat, however, requires some mechanism to provide secure and reliable attachment between the base portion and the textile portion. If such mechanism is ineffective, the textile portion of the separable mat can exhibit turned-up edges, ripples, and/or mis-alignment with the base portion, all of which can result in conditions that are both unsightly (due to mat misalignment, curling, or the like) and unsafe (due to the tripping hazard presented by such turned-up edges, ripples, or other surface irregularities). Additionally, such mats provide impaired ability to remove soil, moisture, or debris from shoes, thereby adversely affecting the essential functionality of the mat.

In order to assure adequate and dependable attachment between the base portion and the textile portion of such mats, and thereby eliminate unsightliness as well as a principal cause of tripping, several methods for detachably securing the base portion to the textile portion have been developed. These methods include, among others, (1) use of a face fastener; (2) use of combination of rough surfaces; (3) use of a mechanical fastening device; (4) use of a chemical adhesion agent; and (5) use of a magnetic material.

One physical and partial adhesion mechanism based upon a hook-and-loop fastener has generally been used as disclosed in, for example, Japanese Patent Publication No. 7450/1984. Described in detail, a female loop portion of the fastener is installed on the back surface of the textile portion of the mat, while a male hook portion of the fastener is installed on the upper surface of the base. Typically, when used with mats that are generally square or rectangular in shape, such fasteners are installed in the corners and along the sides of the mat. However, such placement is unable to avoid wrinkling, which can develop when non-adhered portions of the sides are contacted by the foot traffic. Such wrinkling, and the resulting tripping hazard it presents, can have a dramatic, adverse effect on the safety and appearance of the mat. When the face fastener is used along the entire side of the mat, or substantially so, the mat may become undulated after repetitive washing due to a difference in the shrinkage between the mat fabric and the fastener portion. Regardless of the positioning of the fastener, such fasteners tend to add undesirable thickness and bulk to the mat, thereby causing lumps, depressions, or other surface irregularities in the mat and, where the mat is used near a door with minimal floor clearance, interference with the smooth operation of the door. It has also been observed that such fasteners tend to lose their binding effectiveness, i.e., their adhesion strength, with repeated launderings. In addition, from the standpoint of manufacturing steps, the face fastener must be stitched after the fabric is prepared, thereby increasing the manufacturing cost.

In the case of an attachment mechanism using rough surfaces or a mechanical fastening device, a shape must be formed on the back surface of the fabric that inevitably results in an increase in cost and weight. Moreover, such mechanisms are associated with other shortcomings: an effective adhesive force is difficult to obtain in the vertical direction, the roughened portions themselves become worn out through repetitive laundering of the fabric, and the fabric on the surface tends to deteriorate (wear out), causing the life of the mat to be shortened.

In the case of an attachment mechanism using a releasable adhesive material, the adhesive force decreases upon the infiltration of rain, sand and the like, making it difficult to maintain reliable and effective attachment between the mat portions under all weather conditions.

In contrast with the above-mentioned adhesion methods, the adhesion using magnetic materials maintains an adhesive force favorably and stably against changes in an external environment and varies little even after repeated laundering.

Several attachment mechanisms using magnetic materials already have been proposed for the purpose of releaseably securing together the portions of a separable mat. Such mechanisms are described in, for example, Japanese Laid-Open Patent Publication No. 28413/79, Japanese Laid-Open Utility Model Publication No. 16976/1984, Japanese Laid-Open Utility Model Publication No. 95079/1985 and Japanese Laid-Open Patent Publication No. 118774/1985, and European Patent Specification EP 0653179B1.

As used herein, the term “magnetically active” shall be used to refer to a material that is or that forms a magnet, i.e., it generates a magnetic field. The term “magnetically passive” shall be used to refer to a material that is attracted to a magnet but that cannot, of itself, generate a magnetic field. The term “magnetically interactive” shall refer to a material that is either magnetically active or magnetically passive. The term “magnetically complementary” shall be used to describe magnetically interactive materials that, when brought into close physical proximity, generate or establish an attractive force between the materials. Pairs of magnetically complementary materials include a magnet and a ferrous material (e.g., iron) or, alternatively, a first magnet and a second magnet having a pole orientation that causes it to be attracted to the first magnet.

When using magnetic forces to releasably attach separable mat components, it is important that the textile or removable portion be securely fastened to the base or floor portion. To achieve this result, it is generally understood that the adhesion surface preferably should be smooth and the gap between the opposing magnetically interactive materials in the respective mat portions preferably should be as small as possible, so as to maximize the strength of the attractive forces generated by the magnet(s). In the case of a mat on which pile yarns are implanted, however, it is difficult to completely avoid the unevenness caused by the stitching of pile yarns on the primary backing layer associated with the back surface of the fabric. When an ordinary magnetic material is used, therefore, it is in many cases difficult to establish a sufficiently strong and uniform attachment.

The above-mentioned problem can be solved to some extent by using magnetically active materials that generate a strong magnetic force. In rental mats, however, it is difficult to employ a magnetic material having a particularly strong magnetic force from the standpoint of cost and weight. In addition, when the mat is adhered using a magnetically active material having a particularly strong magnetic force, it becomes difficult to maintain uniformity of adhesion. Moreover, once the mat becomes wrinkled, the strong magnetic forces then tend to oppose any subsequent smoothing action intended to remove the wrinkles.

Because of such circumstances, magnetic force has not yet been practically utilized for fixing the mat to the base though many proposals have been made regarding the use of magnetic force.

### SUMMARY

The object of the present invention therefore is to provide a separable mat having an attachment mechanism that is free from the problems associated with the attachment mechanisms discussed above. By use of the magnetic attachment mechanism discussed herein, the fabric portion of the separable mat may be readily removed for washing or replacing. The fabric portion is unburdened by heavy, bulky, or inflexible features or devices that would interfere with the smooth surface of the mat when in place, and that would contribute to excessive bulk or weight. Importantly, the strength of the attachment between the fabric and base portions of the separable mat is strong and is stable with respect to environmental conditions (e.g., rain, sunlight dust, etc.).

According to one embodiment as will be described herein, there is provided a separable mat comprising a textile component and a base component having a substantially flat surface for supporting the textile component. The textile component has a primary backing substrate, in which textile yarns are implanted or to which yarns are otherwise attached, and may include a magnetically active or (generally preferred) magnetically passive composition or structure applied to or made a part of the backing substrate or some other element comprising the textile component.

Accordingly, the magnetically interactive composition or structure applied to or made a part of the primary backing substrate (or other part) of the textile portion of the separable mat can be either magnetically active (e.g., magnetic particles or thin magnets in the form of disks or small plates or sheet segments) or magnetically passive (i.e., a material that is attracted to a magnet, such as iron particles or disks or small plates or sheet segments comprised of a material that is attracted to a magnet). Alternately, the textile component may include additional backing substrates or layers, one or more adhesive layers, or other structural elements to which magnetically interactive structures such as individual segments of flexible magnetic sheeting, individual ceramic magnets, magnetic particles, or other kinds or forms of magnetically active materials, or, alternatively, magnetically passive structures comprised of particles, sheets, plates, coatings, or the like comprised of materials that are attracted to magnets. It is contemplated that any such magnetically active or passive structures may be secured to or with the textile portion of the separable mat by encapsulation, by being placed into secure pockets formed in the mat, or by other suitable means.

In either case, the location of the magnetically interactive material in the textile portion of the separable mat should correspond to locations of magnetically complementary materials on the base portion of the separable mat, so that the magnetically interactive materials in the textile portion and corresponding magnetically complementary areas on the base portion are in substantial alignment when the textile portion is properly installed on the base portion. It is contemplated that, in order to maximize the versatility and placement flexibility of such separable mats, the base portion could contain a sheet of magnetically interactive material, preferably a magnetically active material, that provides a suitable magnetically complementary surface across the entire surface of the base with which the textile portion comes into contact when properly installed in the base portion. This would allow the same base to be used with textile portions having different arrangements or configurations of magnetically interactive structures, without regard to where the magnetically interactive structures are positioned on the textile portion of the separable mat.

Variations contemplated include multiple textile portions being attached to a single base portion, and variations in the number of magnetically interactive structures and their location, configuration, and means or nature of attachment to the mat, including variations as to the specific layer or portion of the separable mat to which they are attached, as will be discussed in more detail hereinbelow. The mat component may be dyed or printed to meet user specifications, and the base component may also be colored if so desired.

The separable mat described herein uses magnetic force to maintain secure attachment between the removable textile portion of the mat and the normally stationary base portion of the mat, an attachment mechanism that has been found to be generally immune to many of the physical and environmental demands—rain, dust, dirt, repeated launderings, folding, rough or penetrating shoe heels or soles, etc. Unlike the approach used by others, the magnetically interactive structures described herein are not in the form of continuous, full size sheets, but rather in the form of discrete elements that are strategically placed around the edges of the textile portion of the mat, or elsewhere, as desired. By avoiding the use of continuous, full size sheets of magnetically interactive material, particularly in the textile portion of the mat, considerable savings can be achieved in terms of weight, bulk, fabrication costs, ease of laundering, etc.

### BRIEF DESCRIPTION OF DRAWINGS

FIGS. 1 through 7 depict various embodiments of the textile portion of a separable mat constructed in accordance with the teachings herein. In these and other Figures, features carrying the same call-out number may be of the same or similar construction and/or composition, but need not be.

FIGS. 8 through 11 depict alternative magnetically interactive structures applicable to the teachings herein.

FIGS. 12 through 16 depict various embodiments of base portions of separable mats constructed in accordance with the teachings herein.

### DETAILED DESCRIPTION

The separable mat of the present disclosure comprises a textile portion having yarns attached thereto and to which a magnetically interactive material has been affixed, and a complementary base portion that is dimensioned and configured to accommodate the textile portion and thereby form a complete mat structure. Magnetically complementary materials in the base portion, located or configured in a way that facilitates interaction with the magnetically interactive materials associated with the textile portion, serve to provide a releasable attachment mechanism to secure the textile portion to the base portion when the mat is in use.

Some contemplated variations of this concept are discussed below.

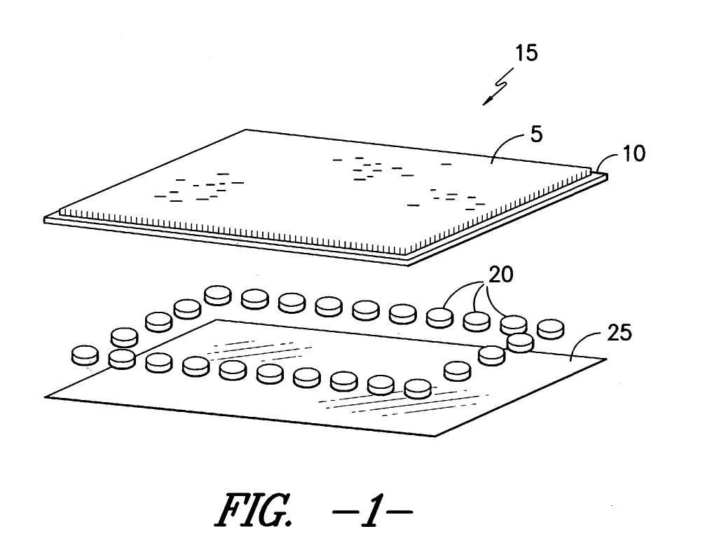

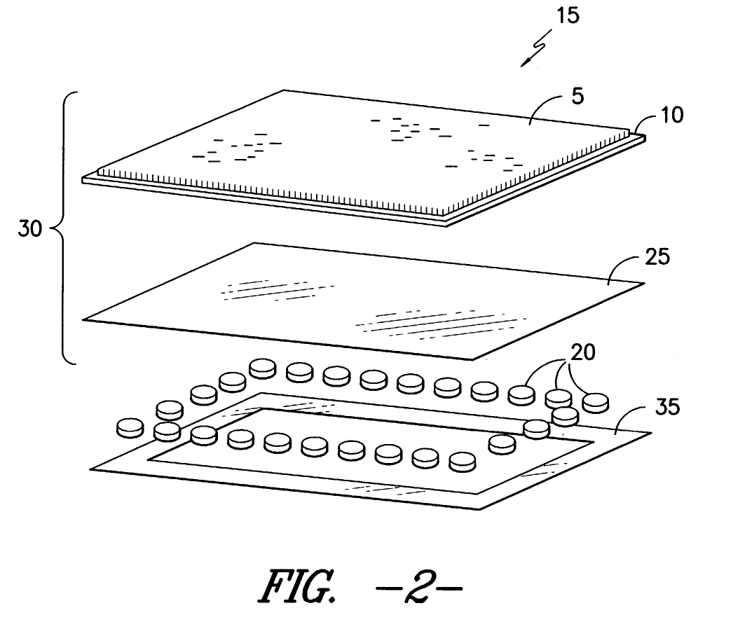

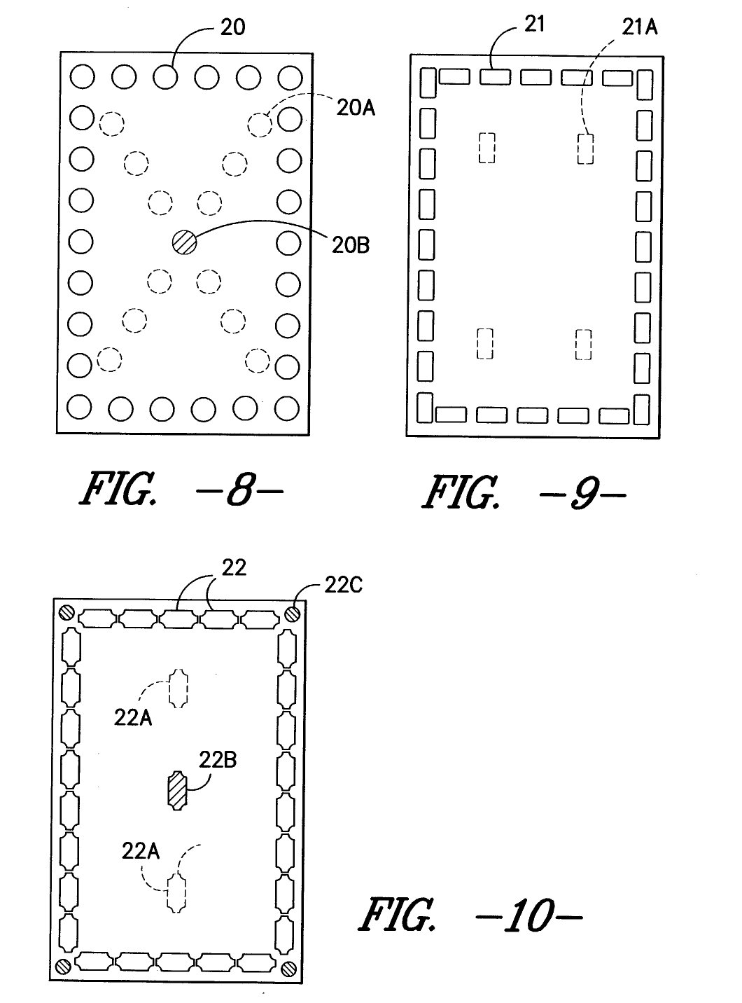

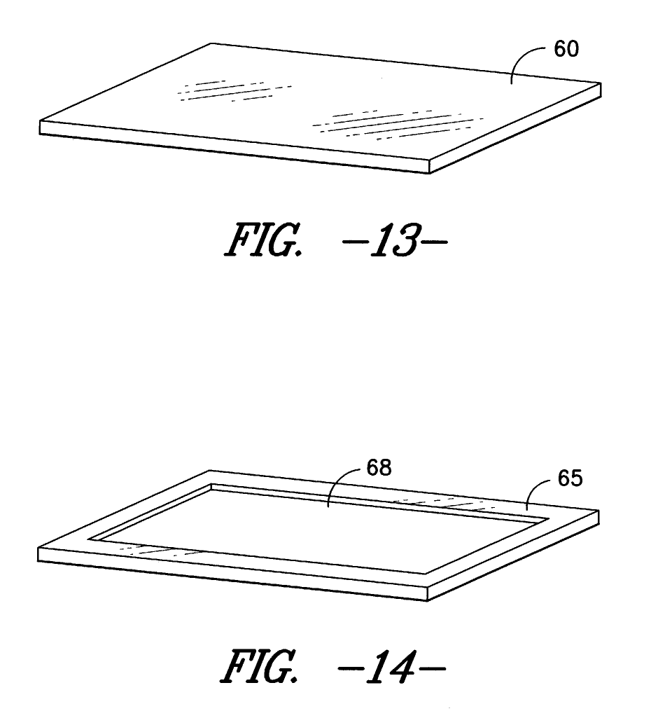

Variations in aspects of separable mat construction include those constructions set forth in FIGS. 1 through 16. FIG. 1 shows one example of a textile portion of a separable mat constructed in accordance with the teachings herein. Fabric 5, which can be comprised of yarns of nylon, polyester, acetate, polypropylene, cotton, wool, acrylic, or other suitable material, or combinations thereof, is attached (e.g., by stitching, tufting, etc.) to a primary backing 10 that can be comprised of a knit, woven, or non-woven structure of nylon, polyester, acetate, polypropylene, acrylic, cotton, wool, or a combination thereof, although the use of nylon or polyester knit fabric is preferred. The textile fabric 5 and the primary backing 10, collectively referred to as the fabric/backing structure and indicated at 15, are then affixed to an adhesive layer 25 comprised of rubber, urethane, polypropylene, polyethylene, nylon, polyester, acetate, acrylonitrile-butadiene-styrene, polyvinyl chloride, and other thermoplastic elastomers or thermoset plastics, or combinations thereof. Hereinafter, this combined structure, indicated at 30 in FIGS. 2 through 7, shall be referred to as the “fabric/adhesive composite structure.” Effectively encapsulated between the primary backing 15 and adhesive layer 25 is an array of individual magnetically interactive structures 20 (which can be comprised of magnetically active or magnetically passive materials), configured in the form of a border positioned somewhat inboard from the edge of the textile portion and located immediately under the fabric/adhesive composite structure. Although inboard positions from about 2 millimeters to about 5 or 10 millimeters are generally preferred, inboard positions from about 1 millimeter to about 50 millimeters from the edge may be used, with relative positions outside these ranges perhaps being appropriate for certain textile portion constructions, base portion constructions, or end-use environments.

In FIG. 2, the fabric/adhesive composite structure 30, with similarly configured magnetically interactive structures 20, is attached to a second adhesive layer 35 so as to effectively encapsulate the magnetically interactive structures 20 arranged around the perimeter of the underside of the fabric/adhesive composite structure 30. The second adhesive layer 35 is configured generally in the form of the arrangement selected for the magnetically interactive structures 20 (e.g., as shown, the magnetically interactive structures 20 are arranged in a configuration that forms a border, slightly inboard of the outside edge of the fabric/adhesive composite structure 30, and the second adhesive layer 35 is configured as a corresponding frame-like rectangle corresponding to that configuration). This second adhesive layer 35 effectively encapsulates or otherwise immobilizes the magnetically interactive structures on the underside of the fabric/adhesive composite structure.

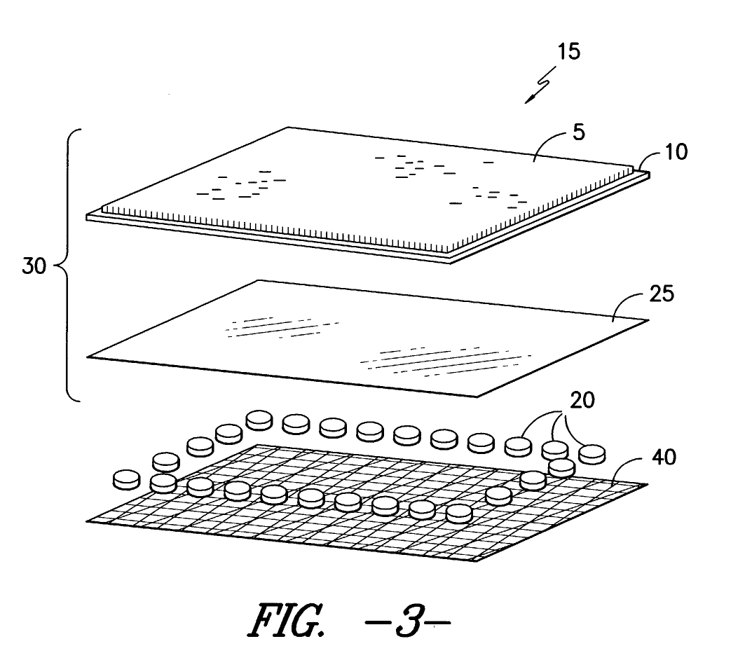

In FIG. 3, the fabric/adhesive composite structure 30 of FIG. 2, with similarly configured magnetically interactive structures 20, is combined with a full size secondary backing 40, which may be constructed from among the same group of materials, and from among the same method of construction as was discussed in connection with the primary backing 10 described in FIG. 1. This secondary backing fabric or scrim 40 effectively encapsulates the magnetically interactive structures 20 (which, as before, can be comprised of magnetically active or magnetically passive materials), and is shown extending the length and width of the fabric/adhesive composite 30.

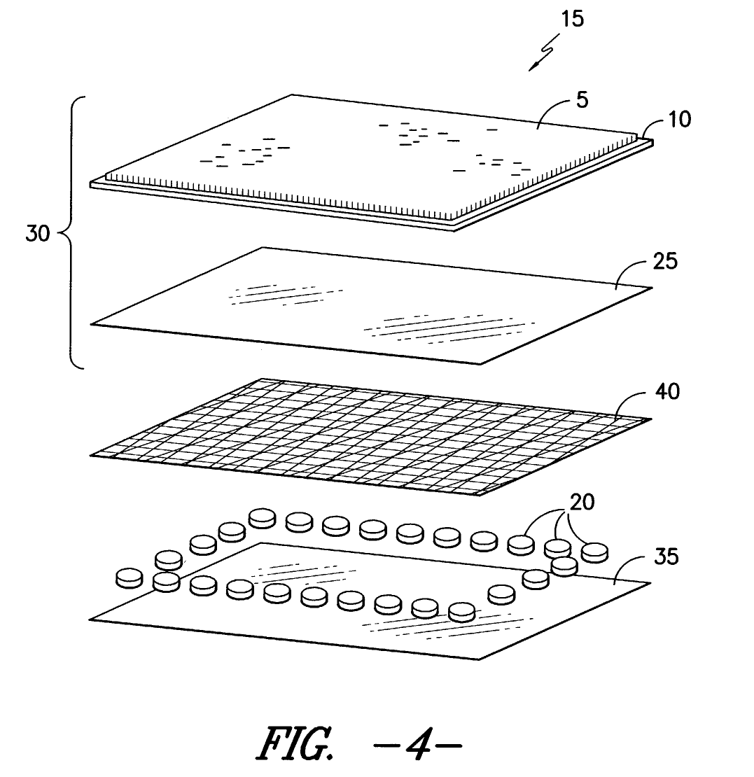

In the structure shown in FIG. 4, the fabric/composite structure 30 of FIG. 2 is augmented by a secondary backing layer 40, which may be constructed from among the same group of materials, and from among the same methods of construction as was discussed in connection with the primary backing 10 described in FIG. 1. Secondary backing 40 is shown completely covering the adhesive surface of the fabric/composite structure 30, i.e., it extends substantially for the entire length and width of the textile portion of the mat. As shown, below this secondary backing layer 40 are arranged a plurality of magnetically interactive active structures 20. In this configuration, however, the magnetically active structures are held in place by a secondary adhesive layer 35, positioned below the secondary first backing layer 40 and dimensioned to cover entirely the secondary backing layer, that effectively encapsulates magnetically interactive structures 20.

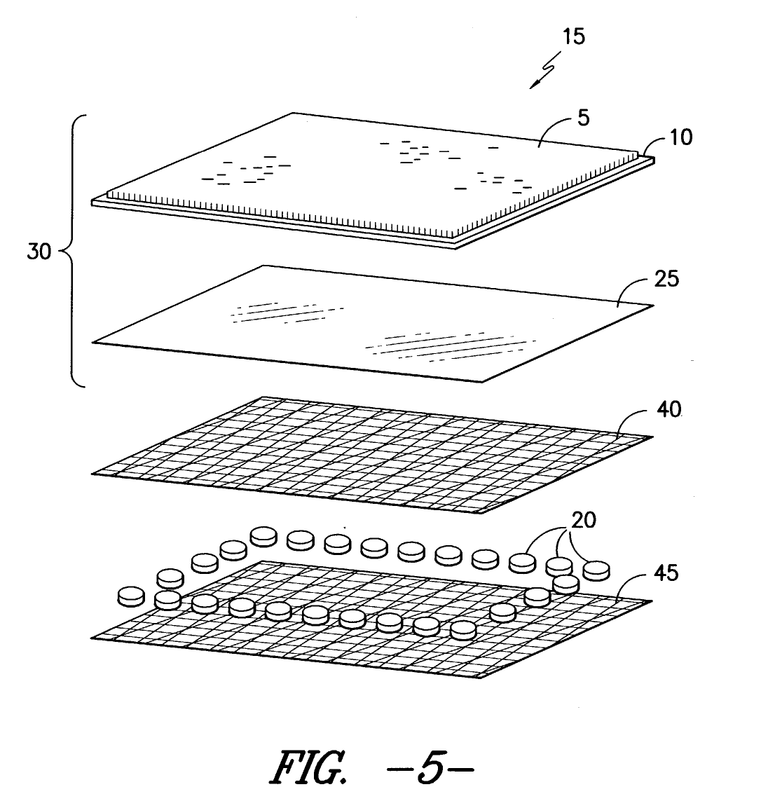

The structure shown in FIG. 5 is similar to the structure of FIG. 4, except that a full size tertiary backing layer 45 is substituted for the secondary adhesive layer 35, and the contiguous, full size secondary and tertiary backing layers 40, 45 serve to “sandwich” the magnetically interactive structures 20 along the perimeter of the textile portion of the separable mat.

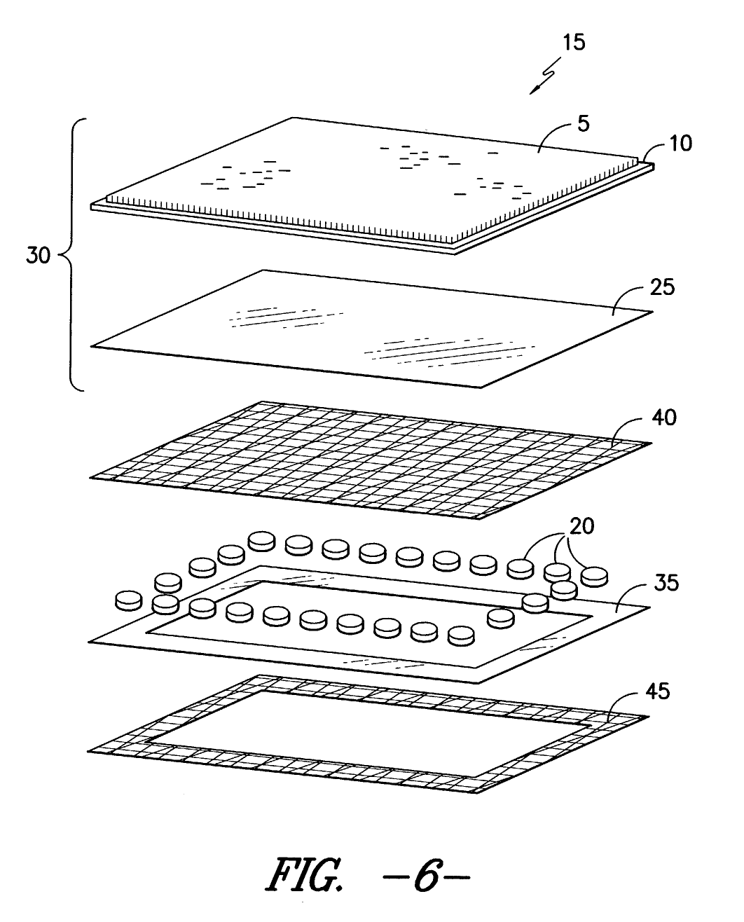

The structure in FIG. 6 also employs a full size secondary backing layer 40, but the tertiary backing layer 45, as well as the intervening second adhesive layer 35, are configured to conform to the arrangement of the magnetically interactive structures 20, as described in connection with FIG. 2. Accordingly, layers 35 and 45 are shown in a border or frame-like configuration.

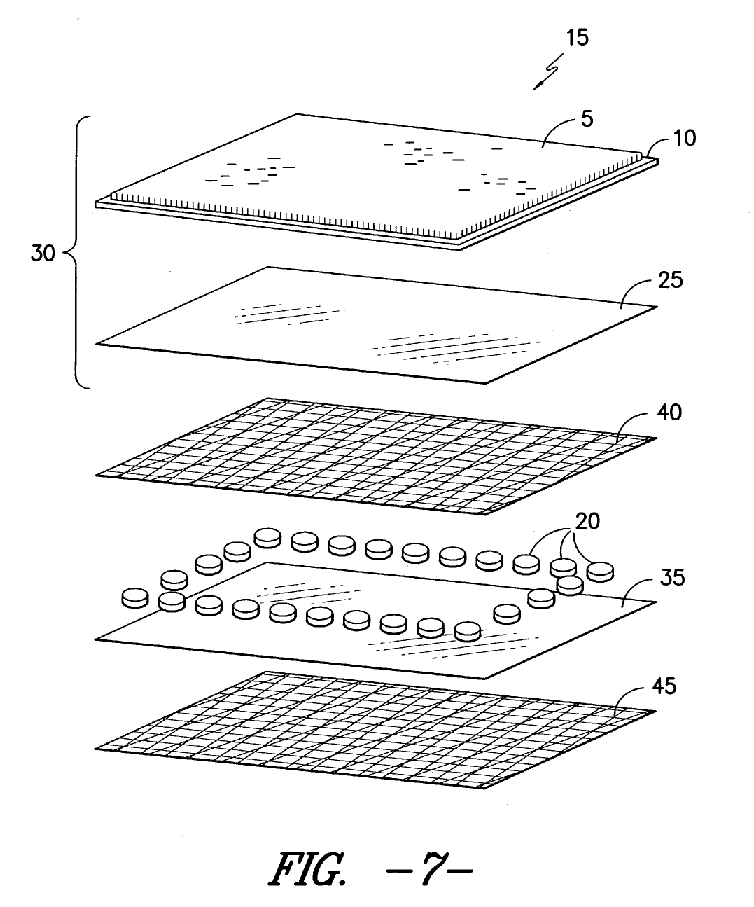

The structure shown in FIG. 7 is analogous to that shown in FIG. 6, except that the secondary adhesive layer 35 and the tertiary backing layer 45 are full-sized, i.e., they extend the length and width of the textile portion. This structure, as well as those shown in FIGS. 1, 3, 4, and 5 accommodates placement of magnetically interactive structures throughout the plane of the textile portion, i.e., in areas apart from the edge of the textile portion, and thereby allows a greater degree of flexibility in the placement of the magnetically interactive structures associated with the textile portion of the separable mat.

For example, the structures may be placed in a border-like configuration, but, to ensure that ripples do not develop in any areas of the mat, additional magnetically active structures may be positioned in various locations in or near the central areas of the textile portion, either singly or as part of a small group (perhaps arranged in a rectangular or circular array), or as part of a larger overall design, such as a pair of intersecting lines extending along the principal diagonals of the carpet mat, thereby forming an “X” pattern. Other configurations, such as ovals, circles, etc., arranged singly or in nested groups, are also contemplated. However, configurations that assure secure attachment of the carpet portion to the base portion along edges and at corners are preferred. Several such configurations are depicted, as examples only, in FIGS. 8 through 12. In these drawings, features indicated by dashed lines or by shading, and identified with letters, are intended as independents optional configurations.

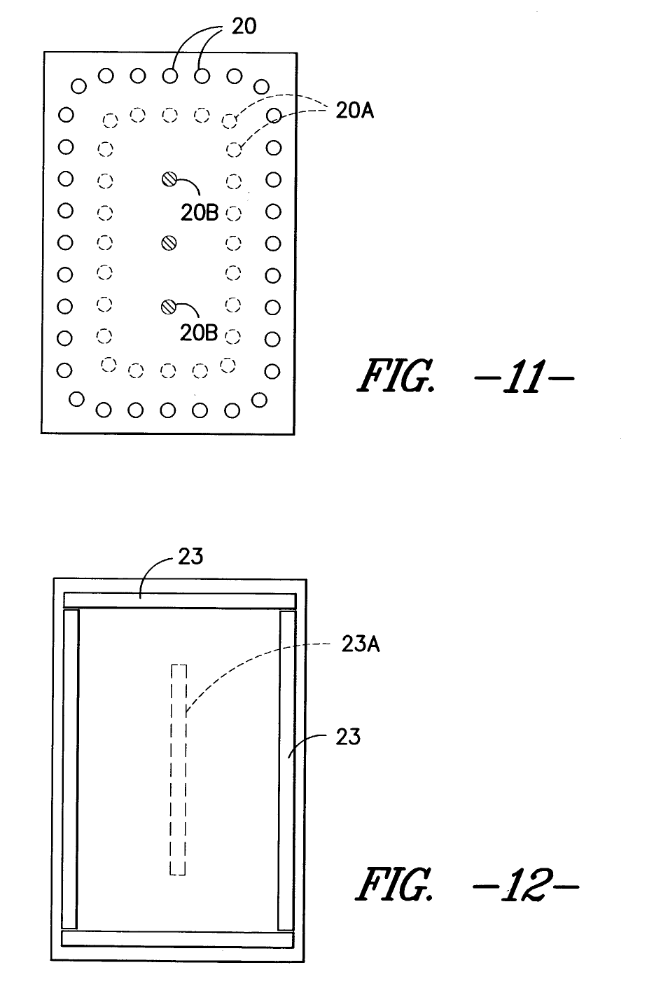

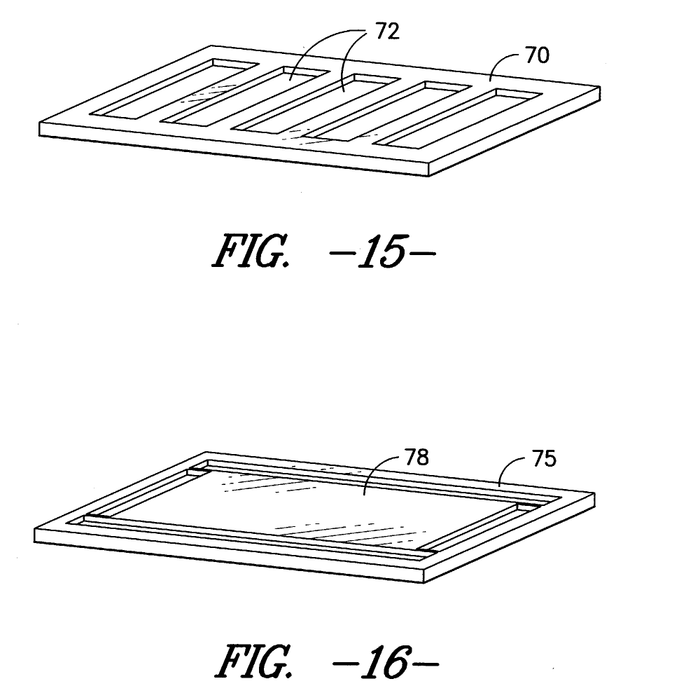

Spacing between adjacent individual magnetically interactive structures is significant to the extent that rippling and unintended detachment of the textile portion of the mat from the base portion of the mat is to be avoided. Accordingly, close spacing of the individual magnetically interactive structures, resulting in relatively small gaps, is recommended. As an example only, it is foreseen that spacings within the range of from about 1 millimeter to about 10 centimeters, and preferably within the range of from about 2 to about 10 to 15 millimeters, may be used, although spacings (uniform or non-uniform) anywhere within these ranges, and perhaps somewhat outside such ranges, may be found to be acceptable or even preferred in some applications. For example, it is contemplated that the individual magnetically interactive structures may be arranged in a contiguous configuration, thereby having substantially no spacing between adjacent structures, as depicted in FIG. 10. It is also contemplated that, where such contiguous configuration is desired, continuous strips of magnetically interactive material can be used rather than contiguously spaced individual elements, as indicated at 23 in FIG. 12.

Alternatively, variations from the structures described above are contemplated. For example, the magnetically interactive structures, particularly the magnetically active structures, may be affixed to the textile portion of the separable mat through the use of pockets formed, for example, in the backing material. This would allow for the magnetically active structures to be removed from the textile substrate prior to laundering.

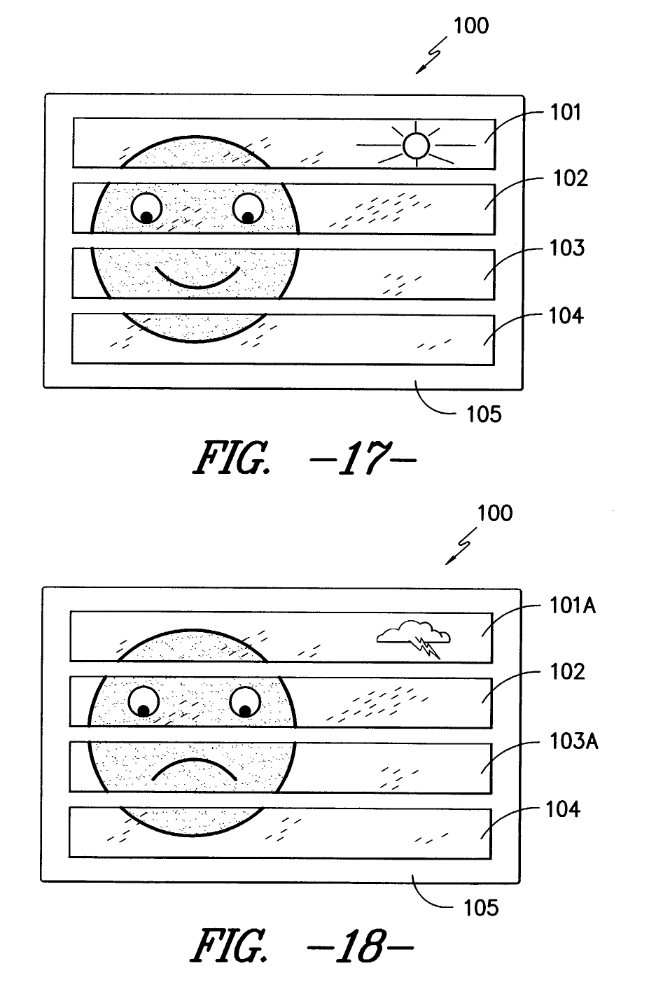

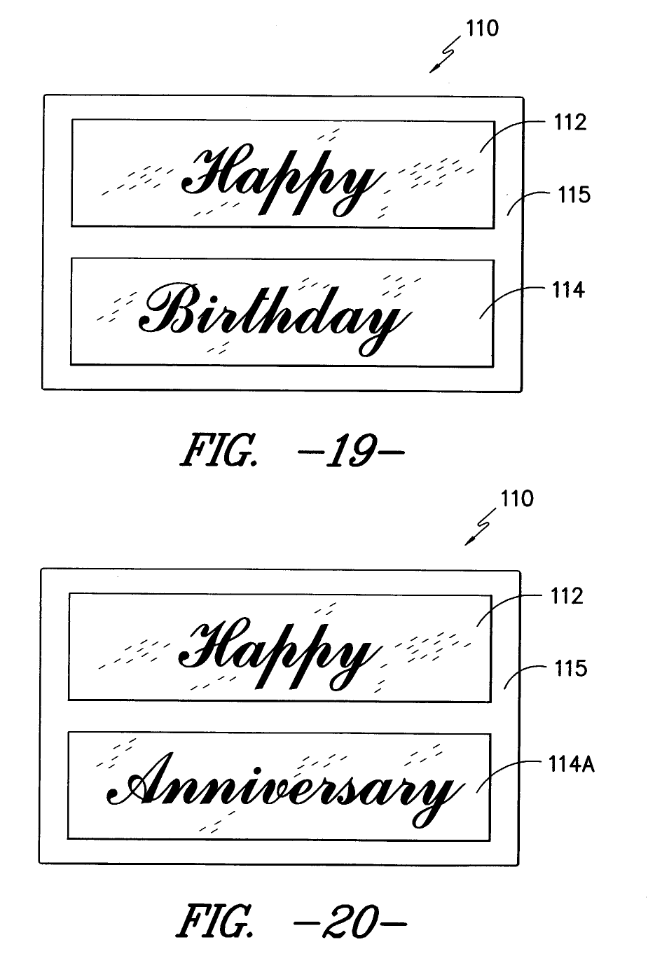

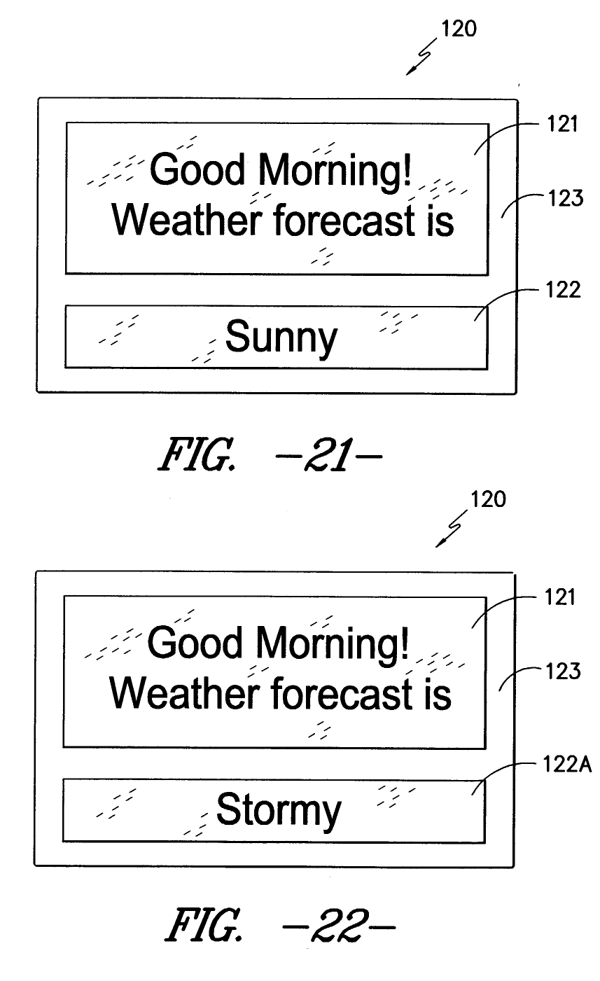

FIGS. 13 through 16 depict various base portion configurations that can be considered for use with the magnetically interactive textile portions discussed above. The base portion is preferably of a shape that complements the shape of the textile component (or components) that are to be used with it. Accordingly, it is typically rectangular. In any case, its edges typically extend laterally beyond the edges of the textile portion of the mat and, in one embodiment, form a recess into which the textile portion of the mat may more-or-less precisely fit, as shown at 68 in FIG. 14. The base portion may have a lip portion around its perimeter, as shown at 78 in FIG. 16, to capture dirt or water from users' footwear. Alternatively, the base component may be substantially flat across its surface for use in areas where low clearance is needed, as depicted in FIG. 13. In yet another embodiment, the base portion may contain a plurality of recesses or planar areas, depicted at 72 in FIG. 15, into which a corresponding number of individual textile components may be respectively secured using one or more arrays or configurations of individual magnetically interactive structures as described herein.

The magnetically interactive structures discussed above are intended to be configured in complementary pairs, so that one structure on the textile portion of the mat is positioned directly adjacent to a magnetically complementary structure positioned on the base portion of the mat. One such structure must be magnetically active (i.e., a magnetic field generator); the magnetically complementary structure may be either magnetically active (but of the proper magnetic polarity so as to generate a net attractive, rather than a repulsive, force) or may be merely magnetically passive (e.g., an iron plate, encapsulated iron dust, etc.). The choice as to which type of structure (i.e., magnetically active or passive) to position in which mat portion (textile or base) depends upon several factors, including the availability of suitably thin, lightweight magnetically active materials.

Generally, it is expected that placement of the heavier, bulkier magnetically interactive structures (which are usually magnetically active structures) in the base will be advantageous, thereby maximizing the advantages of using magnetically interactive structures that are likely to be relatively small, lightweight, flexible, and discrete (which are usually magnetically passive structures) in the removable textile portion of the separable mat. By so doing, it is expected that the textile portion of the mat can remain relatively lightweight and flexible, and will present no special laundering problems (such as magnets being attracted to the laundering equipment drums or the magnets dislodging themselves from the textile portion of the mat during the laundering process). However, the choice as to whether to include magnetically active structures in the textile portion of the mat, either instead of or in addition to placement of magnetically active structures in the base portion of the separable mat, may be dictated by the demands of the application—if, for example, the textile portion of the mat was going to be subjected to high lateral forces, the appropriate choice might be to use magnetically active structures in both the textile portion and the base portion of the mat, to assure the security of the attachment.

The ease with which the textile portion of the separable mat can be replaced or exchanged using the magnetic attachment system described herein has been found to be particularly applicable and appropriate for use where mats are used to convey timely or location-specific information. Examples of such information are as follows:

### EXAMPLE SET #1

### FACTUAL INFORMATION MATS

### Example 1A

### Weather Mat

The mat system includes separate mats that are patterned in such a way as to convey weather conditions. These mats are patterned with text, characters, symbols, and/or graphics to suggest weather conditions such as “Sunny,” “Rainy,” “Cloudy,” “Snowy,” “Windy,” “Hot,” “Cold,” and the like. The mats are placed in a location visible to customers, so that they would learn the weather forecast for the present day. The weather information mats could be used individuals or in combination to create more complex messages (such as “Sunny” and “Hot” or “Windy” and “Cold”). At any time during the day, should weather conditions change, the end-user could change the mat selection to a more appropriate message.

Such a mat may be useful in environments such as hotels where hotel guests may lack familiarity with local weather conditions. Hotel guests, viewing the mats in convenient or central locations, may then choose appropriate attire or outerwear. Especially when travelling internationally—for example, to a country with a language different from his own—the hotel guest is likely to appreciate a symbolic representation of the day's weather conditions.

### Example 1B

### Restroom, Public Bath, or Spa Mat

The mat system includes separate mats that are patterned in such a way as to convey the gender of the intended users of public restrooms, baths, spas, locker-rooms, and the like. In any location where users are segregated by gender, the present mat system may be used. Again, mats are patterned with text, characters, symbols, and/or graphics that indicate “Ladies” or “Gentlemen.” The end-user can place such mats at various locations to direct customers to the appropriate facility.

### EXAMPLE SET #2

### DIRECTIONAL INFORMATION MATS

### Example 2A

### Transportation Mat

The mat system includes separate mats that are used in transportation stations or terminals. Such mats are patterned with text, characters, symbols, and/or graphics that convey directional information to the end-user's customers. Examples of settings in which such a mat system would be useful include airports, bus stations, train stations, subway stations, and the like. Sample messages include “To Departures,” “To Arrivals,” “To Customs,” “To Check-out,” “To Track 24,” “To 2^{nd} Floor,” “To Gate A,” “To Emergency Exit,” and “Ground Transportation This Way.”

### Example 2B

### Postal Service Mat

The mat system includes separate mats that are used in postal delivery services. Such mats are patterned with text, characters, symbols, and/or graphics that convey messages to direct the customer to the appropriate area of the post office. Sample messages include “Customer Service,” “Domestic Delivery,” “International Delivery,” “Parcel Pick-up,” and the like. Customers would be directed by the mats to the area of the post office in which they are seeking service. The mat system, as described, could be used in government-operated postal services, as well as international package and document delivery services.

### Example 2C

### Bank Mat

The mat system includes separate mats that are patterned with text, characters, symbols, and the like to convey messages such as “Make Deposit Here,” “Money Transfer,” “Customer Service,” and “Loan Department.” The mats would direct bank customers to the appropriate locations within the bank, thus helping the customers more easily recognize the area of service that they are trying to locate.

### EXAMPLE SET #3

### GREETING INFORMATION MATS

### Example 3A

### Day-of-the-week Mat

The mat system includes separate mats that are patterned with text, characters, symbols, and the like that represent the days of the week. The end-user places the appropriate mat anywhere in an installation and changes the mat daily.

### Example 3B

### Public Greeting Mat

The mat system includes separate mats that are patterned with text, characters, symbols, and the like that convey a greeting to the end-user's customers. For example, in a hotel, one mat may be printed with the message “Good morning” and another printed with the message “Good night”. Such mats could be placed in front of the elevator in such a way that the hotel patron would read the message on the way into or out of the elevator. The hotel patron would perceive that the hotel management is providing an extra service to him by the greeting.

### Example 3C

### Private Greeting Mat

The mat system includes separate mats that are patterned with text, characters, symbols, and the like that convey a greeting to the end-user's family and/or friends. For example, in the home, a mat may be printed with the message “Happy Anniversary” to celebrate the anniversary of the mat user, members of his family, or his friends. Other variations include the “Happy Birthday” mat, the “Congratulations” mat, the “Best Wishes” mat, and the like. Holiday themes, celebrating religious and secular occasions, are also contemplated. Furthermore, humorous themes may also be expressed. Mats featuring cartoon or other popular fictional characters are contemplated for children.

It should be noted that, because many of the private greeting mats will experience infrequent and sporadic use (e.g., an “Anniversary Mat” may only be used once annually), these mats may be placed in exterior locations without fear of significantly damaging the mat. Specifically, an “Anniversary Mat” may be placed outside a home on the desired day and then removed after some, likely short, time has passed. Because the mat's exposure to sunlight has been limited, the mat's appearance is unlikely to experience any detrimental effects.

### Example 3D

### Message-of-the-day Mat

The mat system includes separate mats that are patterned with text, characters, symbols, and the like that represent uplifting, inspirational, or other messages. These message mats could be used in combination with day-of-the-week mats, for instance. These mats are appropriate for public or private use.

### EXAMPLE SET #4

### SERVICE INFORMATION MATS

### Example 4A

### Taxi Mat

The mat system includes separate mats that are patterned with text, characters, symbols, and the like that are used in taxis, limousines, and other hired cars. The mats provide a message to the service provider's customers. One particular example is “Thank you for using (name of car service)”, which is customized with the name of the particular car service provider.

### Example 4B

### Gaming Establishment Mat

The mat system includes separate mats that are patterned with text, characters, symbols, and the like that are used in casinos, pachinko parlors, or other gaming establishments. Separate mats convey messages such as “Ladies' Day”, “Good Luck”, and the like.

### EXAMPLE SET #5

### Example 5A

The mat system, or the display system, includes separate mats that are patterned with text, characters, symbols, and the like that are pertinent to the time during which it is displayed, such as a “Good Morning” or “Good Evening” mat.

### Example 5B

The mat system, or the display system, includes separate mats that are patterned with text, characters, symbols, and the like that are pertinent to the immediate physical area in which it is display, such as a “Make Deposits Here” mat.

### Example 5C

The mat system, or the display system, includes separate mats that are patterned with text, characters, symbols, and the like that are pertinent to the local conditions for which it is displayed, such as a “Hot and Sunny” weather mat.

### Example 5D

The mat system, or the display system, includes separate mats that are patterned with text, characters, symbols, and the like that are pertinent to personal messages, such as a “Happy Birthday” or “Happy Anniversary” mat.

Specific examples of message mats constructed in accordance with the teachings herein are depicted in FIGS. 17 through 22, in which the separable mats have multiple textile portions that are individually replaceable, and base portions that are adapted to accommodate such multiple textile portions. It should be understood that this system is also adaptable for use with separable mats with a single, full size textile portion.

FIGS. 17 and 18 depict a mat 100 in which the textile portion is divided into four sections 101 through 104. In order to convey the message (here, the weather), only two of the sections, 101 and 103, need to be replaced. As an illustration, these sections have been replaced in FIG. 18 with sections 101A and 103A, indicating that the weather has changed (or is predicted to change) from sunny to rain.

FIGS. 19 and 20 depict a personal message mat in which the top section 112 can remain in place while the bottom section 114 can be easily and economically replaced with a variety of different events (“Birthday”, “Anniversary”, “Mother's Day”, “Father's Day”, “Valentine's Day”, etc.)

FIGS. 21 and 22 depict a variation of the message mat of FIGS. 17 and 18, but the mat depicted combines a greeting with a weather report or prediction. As above, the weather portion of the message is on a separate section that may be easily and economically replaced as needed.

By use of this modular system for building messages, a variety of different messages may be constructed from a relatively few textile portions or sections, thereby saving on manufacturing and acquisition costs and, because the textile portion is relatively small and may only be used occasionally, savings in laundering and wear and tear.

The message portion of the present mat may be created by any patterning technique known in the art, including, but not limited to, dye injection, graphic tufting, screen printing, pad dyeing, flocking, or combinations thereof. Dye injection is preferred because of the unlimited pattern making capability and opportunity for mass customization. One piece of equipment capable of performing such patterning is described in U.S. Pat. No. 4,084,615 to Klein and Stewart.

Such patterning may be achieved by using acid dyes, basic or cationic dyes, disperse dyes, metallized or premetallized dyes, reactive dyes, or any combination thereof, although reactive dyes are most preferred. The use of reactive dyes in patterning is preferred, because they result in a product that has excellent washfastness over repeated launderings.

Washfastness has historically been a particular dilemma to the industrial laundries, which are often called upon to service dust control mats. In order to be cost-efficient, the laundry must wash all of their message mats together in large washing machines, rather than segregating mats by color. Because of the dyes used conventionally, the mat color transfers to other mats in the washing machine, causing cross-staining problems. For example, when laundering a red, a black, and a yellow mat together (each of which has been dyed with acid dyes), the black dye tends to migrate onto the red and the yellow mats. The red dye also tends to migrate onto the yellow mat. The result is that the mats that have lost dye appear faded, while the mats that receive dye appear dingy or dirty.

However, conventional wisdom in the laundry industry is that, if acid dyes (or dyes with similar transfer properties) are not used, then the mat colors will fade, over time, from exposure to sunlight. The industrial laundry, therefore, must choose between dye transfer problems and weather-related fading problems. Because light-fastness has historically been deemed more important to many industrial laundries, the prior mats have been made with conventional dyes that tend to have poor washfastness.

The present mat system addresses the problem of dye transfer by replacing acid dyes with reactive dyes. The wash durability of reactive dyes helps significantly reduce the likelihood of dye transfer during laundering, thus solving a significant problem experienced by the industrial laundries. Furthermore, since the intended use of the present mat system is typically in interior locations, the light-fastness of the reactive dyes is not problematic.

What is claimed is:

1. A separable floor mat comprising a base component and at least one mat component, wherein said mat component includes a magnetic constituent and said base component includes a magnetic constituent, said mat component and said base component are magnetically complimentary, wherein said mat component further comprises a backing substrate and mat piles implanted in said backing substrate, said mat piles being printed with reactive dyes to convey information to users thereof.

2. The floor mat of claim 1, wherein said mat component includes at least one magnetically active component adhered to the backing substrate, said magnetically active component being selected from the group consisting of magnetic particles, magnetic disks, and magnetic sheets, and wherein said base component includes a magnetically inactive component.

3. The floor mat of claim 1, wherein said mat component includes a magnetically inactive component and wherein said base component includes at least one magnetically active component adhered to the backing substrate, said magnetically active component being selected from the group consisting of magnetic particles, magnetic disks, and magnetic sheets.

4. The floor mat of claim 2, wherein said mat component includes a magnetic film adhered to the backing substrate and wherein said base component includes magnetic particles incorporated therein.

5. The floor mat of claim 4, wherein an adhesive layer is positioned between the magnetic film that is adhered to the backing substrate and said base component that includes magnetic particles incorporated therein.

6. The floor mat of claim 1, wherein said mat component includes a magnetically active component adhered to the backing substrate and wherein said base component includes a magnetically active component.

7. The floor mat of claim 1, wherein said information conveyed to users thereof is selected from the group consisting of factual information, directional information, greeting information, service information, messages pertinent to the time during which said floor mat is displayed, messages pertinent to the local conditions for which said floor mat is displayed, messages pertinent to the immediate area in which said floor mat is displayed, and personal messages.
